(19) United States
(12) Patent Application Publication
(10) Pub. No.: US 2005/0243028 A1
(43) Pub. Date: Nov. 3, 2005

(54) Display panel drive method

(75) Inventors: Junichi Usui, Fukuroi-shi (JP); Naruhiro Sato, Fukuroi-shi (JP); Takashi Akimoto, Fukuroi-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/108,779

(22) Filed: Apr. 19, 2005

(30) Foreign Application Priority Data
Apr. 27, 2004 (JP) 2004-130766

(51) Int. Cl. G09G 3/28

(52) U.S. Cl. 345/63

(57) ABSTRACT

A display panel drive method performs image display at a good brightness level regardless the pattern of the image while decreasing power consumption. In this drive method, the number of emission of pixel cells assigned to each subfield is changed based on the peak brightness level of the input video signal.

### BACKGROUND OF THE INVENTION

1. Field of the Invention

The present invention relates to a method of driving a display panel to display images.

2. Description of the Related Art

As the screen size of display devices increases, slim display devices are demanded, and various slim display devices are commercialized. One of the popular slim devices is an AC discharge type plasma display panel (hereafter called “PDP”). A PDP includes a plurality of column electrodes, and a plurality of row electrode pairs which are arranged perpendicular to the column electrodes. Each row electrode pair defines a single scanning line (or display line). Discharge space is defined in the PDP. The row electrodes and column electrodes are coated by a dielectric layer so that these electrodes are sealed from the discharge space. A pixel cell is formed at each intersection of one row electrode pair and one column electrode. The pixel cells serve as pixels.

In order to drive a PDP so as to produce an image with desired halftone brightness, a subfield method (or subframe method) is often used. According to the subfield method, the display period of one field is divided into a plurality of subfields, and the pixel cells are driven to emit light respectively for each subfield. Each subfield has its own weighting, and a number of emissions (or an emission period) is assigned to each subfield based on its own weighting. For example, if the pixel data of each pixel derived from the input video signal is 8-bit data, one field period is divided into 8 subfields. A simultaneous reset step, pixel data write step and emission sustaining step are sequentially executed in each subfield.

In the simultaneous reset step, all of the pixel cells of the PDP are simultaneously discharged (reset discharge) so as to form wall charges in all of the pixel cells. In the pixel data write step, discharge is generated selectively (selective erase discharge) for each pixel cell in accordance with a logical level of the pixel data bit corresponding to the subfield concerned. The wall charges disappear in those pixel cells in which the selective erase discharge is generated, and these pixel cells are set to a non-emission condition (unlit condition). In other pixel cells in which the selective erase discharge is not generated, on the other hand, wall charges remain, so these pixel cells are set to an emission condition (lit condition). In the emission sustaining step, only those pixel cells which are set to the emission condition are repeatedly discharged (sustaining discharge) for the number of times (emission period) assigned to the subfield concerned. As a result, intermediate brightness, according to the total count of the sustaining discharge generated in the emission sustaining steps of the respective eight subfields, is recognized. For example, by assigning the number of times of sustaining discharge to the eight subfields at the ratio of 1:2:4:8:16:32:64:128, 256 (=2⁸) intermediate brightness or 256 grayscales can be produced using a combination of the eight subfields in one field display period.

However, when such grayscale driving is used and a video signal representing a high brightness image is supplied, then the number of times of sustaining discharge, which is generated in a unit display period (one field display period), increases and power consumption increases.

Therefore, a method for low power consumption was proposed by, for example, Japanese Patent Kokai (Application Laid-open) No. 2003-216094. This control method limits power consumption under a predetermined value, regardless the input video signal (see FIG. 8 of Japanese Patent Kokai No. 2003-216094). In this control method, the number of times of sustaining discharge to be assigned to each subfield is changed based on the average brightness of the input video signal in consideration of the luminance at the location of the PDP.

According to this low power consumption control, if an image signal representing an image, of which the brightness change within one screen is small and of which the average brightness is low, are supplied, an image darker than the desired brightness is often perceived. This will be discussed with reference to FIG. 1A and FIG. 1B.

An image shown in FIG. 1A of the accompanying drawings has the same average brightness as an image shown in FIG. 1B of the accompanying drawings. The image of FIG. 1A has a uniform brightness (e.g., 20% of the maximum brightness) in one screen (e.g., an entirely gray image). The image of FIG. 1B has the maximum brightness in its 20% area (white area) and the minimum brightness in its 80% area (black area).

If the above mentioned low power consumption control is applied to these images, the number of times of sustaining discharge is decreased for all the pixels in the case of displaying the image shown in FIG. 1A, and the number of times of sustaining discharge is decreased for 20% of all the pixels in the case of displaying the image shown in FIG. 1B. As a result, a darker image is perceived when the image of FIG. 1A is displayed because the brightness difference within one screen is small, if compared with the image of FIG. 1B whose brightness difference in one screen is large.

### SUMMARY OF THE INVENTION

One object of the present invention is to provide a display panel drive method which performs image display at a good brightness level regardless the patterns of images while decreasing power consumption.

According to one aspect of the present invention, there is provided an improved method for driving a display panel. The display panel includes a plurality of pixel cells. Each field of input video signal is divided into a plurality of subfields and the pixel cells are caused to emit light for each subfield. Each subfield is assigned a number of emissions (emission period) of the pixel cells. The display panel driving method includes detecting a peak brightness level of an input video signal, changing the number of emission which is assigned to each subfield based on the peak brightness level of the input video signal, and applying a sustain pulse to the display panel to cause the pixel cells to emit light for the number of times of emission assigned to the subfield concerned, during that subfield. This drive method displays an image at a decent brightness level regardless the pattern of image while decreasing power consumption of the display panel.

According to a second aspect of the present invention, there is provided another display panel drive method. Each field of input video signal is divided into a plurality of subfields. The display panel is driven for each subfield. The display panel has a plurality of pixel cells. The display panel drive method includes detecting an average brightness level of an input video signal and detecting a peak brightness level of the input video signal. The display panel drive method also includes assigning a number of emission of the pixel cells to each subfield based on the average and peak brightness levels of the input video signal. The display panel drive method also includes applying a sustain pulse to the display panel to cause the pixel cells to emit light for the number of the emission assigned to the subfield concerned, during that subfield. This drive method also displays an image at a good brightness level regardless the pattern of image while decreasing power consumption.

These and other objects, aspects and advantages of the present invention will become apparent to those skilled in the art from the following detailed description and appended claims when read and understood in conjunction with the accompanying drawings.

### BRIEF DESCRIPTION OF THE DRAWINGS

FIG. 1A shows an image of which the average brightness is low and the brightness difference is small within one screen;

FIG. 1B shows an image of which the average brightness is low and the brightness difference is large within one screen;

FIG. 2 depicts a general configuration of a plasma display apparatus which drives a plasma display panel according to a drive method of the present invention;

FIG. 3 shows a data conversion table used by a pixel drive data generation circuit, together with an emission drive pattern within one field;

FIG. 4 depicts an example of the emission drive sequence based on the subfield method;

FIG. 5 is a flowchart for setting a number of sustaining discharge;

FIG. 6 is another flowchart for setting a number of sustaining discharge; and

FIG. 7A to FIG. 7D are a set of diagrams depicting the emission drive sequence when the number of subfields is changed according to the peak brightness level.

### DETAILED DESCRIPTION OF THE INVENTION

Embodiments of the present invention will now be described with reference to the drawings.

### Embodiment 1

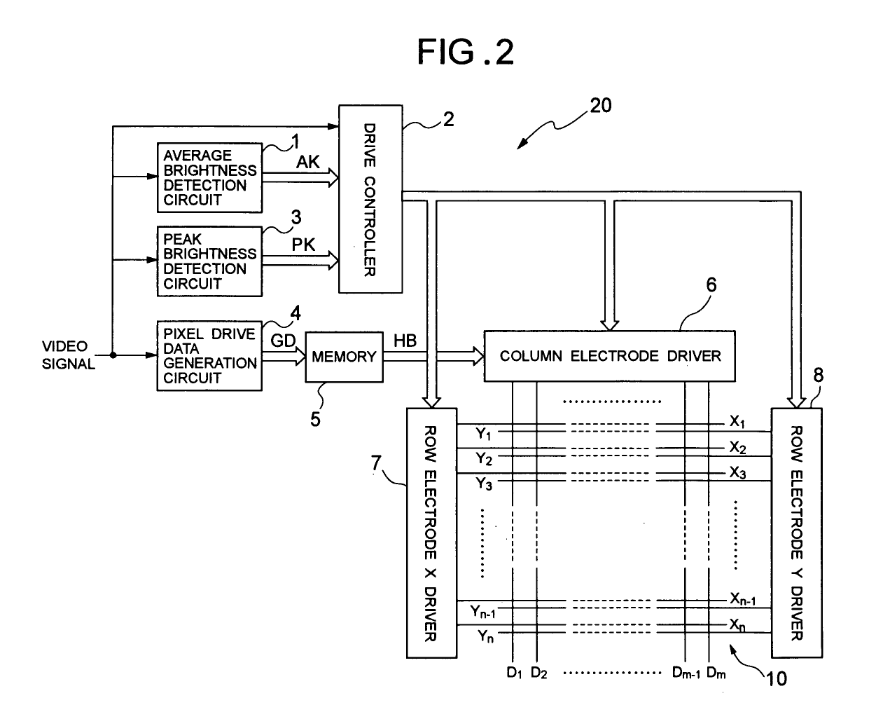

Referring to FIG. 2, a general configuration of a plasma display apparatus 20 will be described. The plasma display apparatus 20 drives a plasma display panel (PDP) 10 according to the drive method of the present invention. The plasma display panel 10 is an example of display panel.

In FIG. 2, the plasma display apparatus 20 includes a PDP 10 and a drive unit for driving the PDP 10.

The PDP 10 includes a front transparent substrate (not illustrated). On the front substrate, n row electrodes X₁-Xₙ and n row electrodes Y₁-Yₙ are alternately arranged. The PDP 10 also includes a rear substrate (not illustrated). On the rear substrate, m column electrodes D₁-Dₘ are provided as address electrodes. The column electrodes D extend perpendicularly to the row electrodes X and Y. In the PDP 10, a pair of row electrodes X and Y which are adjacent to each other constitute one display line of the PDP 10. A discharge space where discharge gas is sealed is created between the front substrate and the rear substrate. A pixel cell is constructed at each inter-section of each row electrode pair and column electrode including this discharge space. The pixel cells serve as pixels.

The average brightness detection circuit 1 calculates an average brightness level for each field (frame) based on the input video signal, and supplies an average brightness signal AK indicating this average brightness level to the drive control circuit 2.

The peak brightness detection circuit 3 detects the maximum brightness for each field (frame) period based on the input video signal, and supplies the peak brightness signal PK indicating the maximum brightness level to the drive control circuit 2.

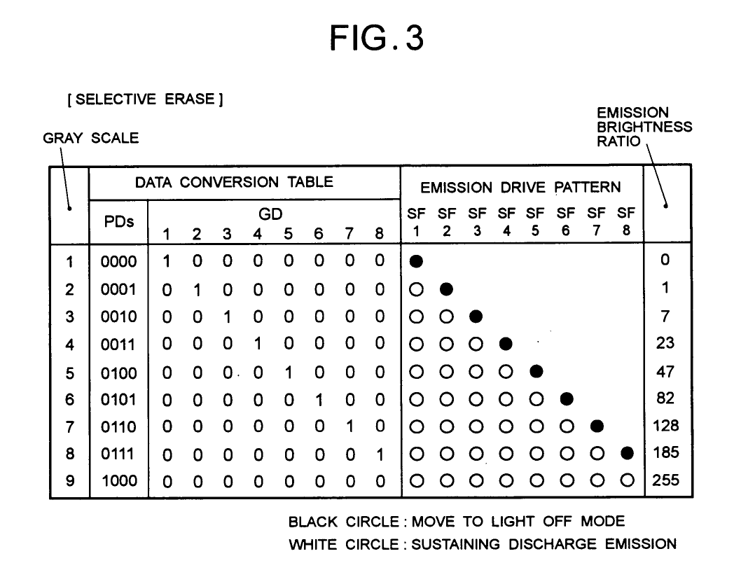

The pixel drive data generation circuit 4 first performs multi-grayscale processing, such as error diffusion and dither processing, on the input video signal. In the error diffusion processing, the input video signal is converted into 8-bit pixel data, for example, for each pixel, and the upper 6 bits are regarded as display data and the remaining lower 2 bits as error data. Each error data in the pixel data corresponding to each peripheral pixel is weighted and added, and the resultant is reflected in the display data. By this operation, the brightness of the lower 2 bits in the original pixel is pseudo-represented by peripheral pixels, and therefore a brightness grayscale representation equivalent to the 8-bit pixel data becomes possible by 6-bit display data. Dither processing is performed on the 6-bit error-diffused pixel data. In the dither processing, a plurality of pixels adjacent to each other are regarded as one pixel unit, and dither coefficients, which have different coefficient values from each other, are assigned and added respectively to the error-diffused pixel data corresponding to the pixels in this one pixel unit. By adding such dither coefficients, a brightness corresponding to 8-bits can be represented by the upper 4 bits of the dither-coefficient-added pixel data if viewed in one pixel unit. Therefore the upper 4 bits of the dither-coefficient-added pixel data are extracted, and these are regarded as multi-grayscale pixel data PDs. Then the pixel drive data generation circuit 4 converts the 4-bit multi-grayscale pixel data PDs into an 8-bit pixel drive data GD in accordance with the data conversion table shown in FIG. 3, and supplies the pixel drive data GD to the memory 5.

The memory 5 sequentially writes the pixel drive data GD. When the memory 5 completes writing of one field (one frame) of data, the memory 5 regards this one field of pixel drive data GD as pixel drive data bits DB1-DB8 as shown below. One field of pixel drive data GD is separated for bit digits.
DB1: first bit of the pixel drive data GD
DB2: second bit of the pixel drive data GD
DB3: third bit of the pixel drive data GD
DB4: fourth bit of the pixel drive data GD
DB5: fifth bit of the pixel drive data GD
DB6: sixth bit of the pixel drive data GD
DB7: seventh bit of the pixel drive data GD
DB8: eighth bit of the pixel drive data GD

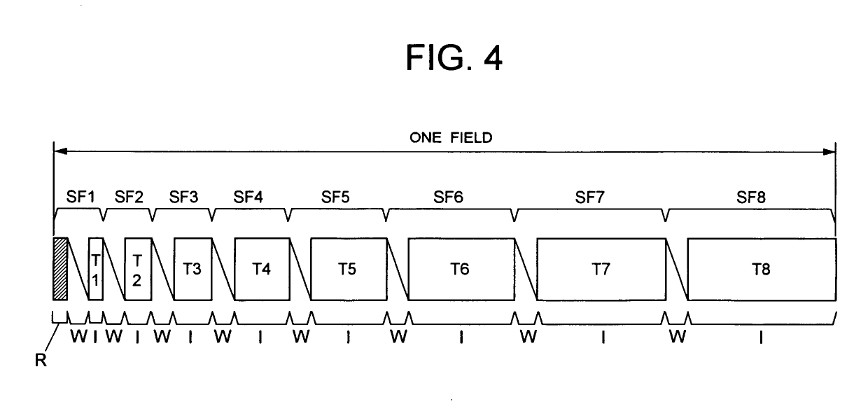

The memory reads each data bit DB1-DB8 in the corresponding subfield SF1-SF8 (see FIG. 4), and supplies it to the column electrode drive circuit 6.

The drive control circuit 2 supplies various control signals to drive the PDP 10 to the column electrode drive circuit 6, row electrode Y drive circuit 7 and row electrode X drive circuit 8 respectively according to the emission drive sequence shown in FIG. 4, which uses the subfield method (subframe method).

In the emission drive sequence shown in FIG. 4, the address step W and sustaining step I are executed respectively in each subfield SF1-SF8 during one field (one frame) of the display period. The reset step R is executed before the address step W only in the first subfield SF1.

In the reset step R, the row electrode Y drive circuit 7 and the row electrode X drive circuit 8 simultaneously apply a reset pulse to all the row electrodes Y₁-Yₙ and row electrodes X₁-Xₙ the PDP 10. Upon application of the reset pulse, a reset charge is generated in all the pixel cells of the PDP 10, and all the pixel cells are initialized to the light ON mode (lit mode). Sustaining discharge emission (described later) is possible in the light ON mode state.

In the address step W of each subfield SF1-SF8, the row electrode Y drive circuit 7 sequentially applies a scanning pulse to the row electrodes Y₁-Yₙ. In the meantime, the column electrode drive circuit 6 converts each of the pixel drive data bits DB into a pixel data pulse having a voltage according to the logical level of the pixel drive data bit DB concerned, and applies the m pixel data pulses to the column electrodes D₁-Dₘ respectively for one display line at a time in synchronization of the application timing of the scanning pulse. If the pixel drive data bit DB is logical level 1, for example, a high-voltage pixel data pulse is applied to the column electrodes, and the pixel cells shift from the light ON mode to the light OFF mode (unlit mode). If the pixel drive data bit DB is logical level 0, on the other hand, a pixel data pulse with low voltage is applied to the pixel cells corresponding to the pixel drive data bit, and the pixel cells maintain the current status (light ON mode or light OFF mode).

In the sustaining step I of each subfield SF1-SF8, the row electrode Y driver 7 and the row electrode X driver 8 repeats applying the sustain pulses to the row electrodes Y₁-Yₙ and the row electrodes X₁-Xₙ for the number of times T. T is the number of emission (emission period) of each subfield. The number of emission T of each subfield is decided by the drive control circuit 2 (described later). In other words, as FIG. 4 shows, sustain pulses are applied to each of the row electrodes Y₁-Yₙ and row electrodes X₁-Xₙ repeatedly for the number (period) of emission T1 during the sustaining step I of the subfield SF1, for the number (period) of emission T2 during the sustaining step I of the subfield SF2, . . . and for the number (period) of emission T8 during the sustaining step I of the subfield SF8. Each time the sustain pulse is applied, only those pixel cells which are set to the light ON mode generate a sustaining discharge, and maintain the emission state along with the discharge.

In the above-described light emission driving, the chance when the pixel cells change from light OFF mode status to the light ON mode status is only the reset step R of the first subfield SF1 among the eight subfields SF1-SF8. Therefore according to the nine types of pixel drive data GD shown in FIG. 3, pixel cells initialized to the light ON mode in the reset step R of the subfield SF1 remain in the light ON mode until they are set to the light OFF mode in the address step W of a certain subfield (indicated by a black circle) among the eight subfields SF1-SF8. Therefore in the sustaining steps I of the respective subfields (indicated by a white circle) existing during this period, pixel cells emit light continuously for the number of times (or period) assigned to the subfield concerned. As a result, an intermediate brightness, according to the total number of times of emission executed in the sustaining steps I of the subfields SF1-SF8 throughout one field, is visually recognized. In other words, according to the nine types of pixel drive data GD shown in FIG. 3, 1st-9th grayscale driving which can represent nine different intermediate brightness can be performed.

Now the operation to decide how many times the emission should occur (emission sustaining period) in each subfield will be described. This operation is carried out by the drive control circuit 2.

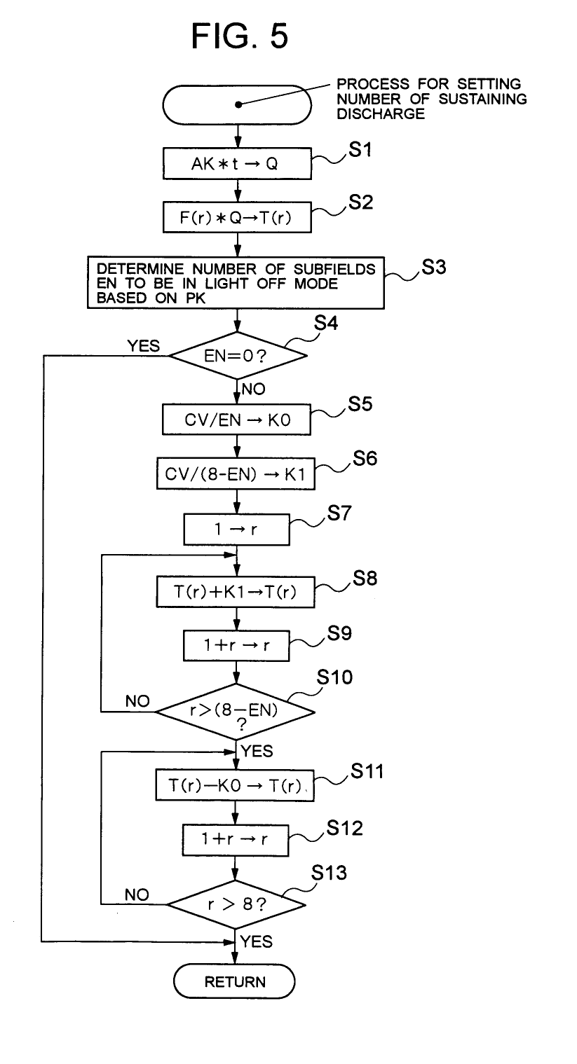

The drive control circuit 2 executes control shown in FIG. 5 (i.e., sustaining number setting process) each time one field (one frame) of input video signal is supplied.

First the drive control circuit 2 multiplies the average brightness level of each field, indicated by the average brightness signal AK supplied from the average brightness detection circuit 1, by a predetermined coefficient t, so as to decide the coefficient Q for the number of emission (step S1). Then the drive control circuit 2 multiplies each of the brightness coefficients F1-F8 indicating the brightness weight of the subfields SF1-SF8 by the coefficient Q, so as to determine the number of emission T1-T8 in the sustaining step I of each subfield SF1-SF8 (step S2).

For example, the brightness coefficients F1-F8, which indicate the brightness weight of the subfield SF1-SF8, have the following values:
F1: 1
F2: 6
F3: 16
F4: 24
F5: 35
F6: 46
F7: 57
F8: 70

By executing steps S1 and S2, the numbers of emission T1-T8 in the sustaining steps I of the respective subfields SF1-SF8 are determined according to the average brightness level of the input video signal of each field (frame).

Then based on the peak brightness signal PK supplied from the peak brightness detection circuit 3, the drive control circuit 2 finds the subfields in which all the pixel cells become light OFF mode among the eight subfield SF1-SF8, and takes the number of such subfields as the number of the light OFF subfields EN (step S3). For example, if the maximum brightness level that can be represented by the driving scheme shown in FIG. 3 and FIG. 4 is “255” and the peak brightness level indicated by the peak brightness signal PK is “82”, then no driving for grayscale with a relatively high brightness, such as 9th grayscale, 8th grayscale and 7th grayscale shown in FIG. 3, is performed for all the pixel cells. In other words, all the pixel cells are set to the light OFF mode in the subfields SF6, SF7 and SF8, so that the number of light OFF subfields EN is “3”.

Then the drive control circuit 2 determines whether the number of light OFF subfields EN is “0” or not (step S4). In step S4, if the number of light OFF subfields EN is determined to be “0”, then the drive control circuit 2 ends this process of setting the number of sustaining emission, and moves to the execution of the drive control shown in FIG. 3 and FIG. 4. In other words, the number of emission T (T1-T8), obtained in step S2, is used as the number of times (period) of sustaining discharge to be executed in the sustaining step I of the subfield SF concerned (SF1-SF8).

If it is determined in step S4 that the number of light OFF subfields EN is not “0”, then the drive control circuit 2 divides a predetermined adjustment value (i.e., emission number change amount) CV by the number of light OFF subfields EN, and takes the resultant as the emission number decrease amount K0 (step S5). Then the drive control circuit 2 divides the adjustment value (i.e., emission number change amount) CV by the value acquired when the number of light OFF subfields EN is subtracted from the total number of subfields “8”, and takes the result as the emission number increase amount K1 (step S6). Then the drive control circuit 2 puts “1” as the initial value of the subfield designation value r (step S7). The drive control circuit 2 selects the number of emission T(r) based on the subfield designation value r among the numbers of emission T1-T8 obtained in step S2, and adds the emission number increase amount K1 to this number of emission T(r) so as to take the resultant as a new number of emission T(r) (step S8). For example, if the subfield designation value r is “1”, then the emission number increase amount Kl is added to the number of emission T1 obtained in step S2 and the resultant is taken as a new number of emission T1. After step S8, the drive control circuit 2 adds “1” to the subfield designation value r and takes the sum as a new subfield designation value r (step S9). The drive control circuit 2 determines whether the subfield designation value r is greater than the value acquired by subtracting the number of light OFF subfields EN from the total number of subfields “8” (step S10). If the answer in step S10 is NO, the drive control circuit 2 returns to step S8 and repeats the above mentioned operation. If the answer in step S10 is YES, then the drive control circuit 2 proceeds to step S11. In other words, the drive control circuit 2 selects the number of emission T(r) indicated by the subfield designation value r among the numbers of emission T1-T8 obtained in step S2, subtracts the emission number decrease amount K0 from the number of emission T(r) and takes the result as a new number of emission T(r) (step S11). Subsequently, the drive control circuit 2 adds “1” to the subfield designation value r and takes the sum as a new subfield designation value r (step S12). After that, the drive control circuit 2 determines whether the subfield designation value r is greater than the total number of subfields “8” (step S13). If it is determined in step S13 that the subfield designation value r is not greater than “8”, the drive control circuit 2 returns to step S11 and repeats the above mentioned operation. If it is determined in step S13 that the subfield designation value r is greater than “8”, then the drive control circuit 2 ends the process of setting the number of sustaining discharge and moves to the execution of the drive control shown in FIG. 3 and FIG. 4. In other words, the new numbers of emission T1-T8, acquired by performing the emission time change process in steps S3-S13 on the emission times T1-T8 obtained in step S2, are set as the numbers (periods) of sustaining discharge to be executed in the sustaining steps I of the subfield SF1-SF8 respectively.

As described above, the process of setting the number of sustaining discharge shown in FIG. 5 first decides the numbers of emission T1-T8 of the sustaining discharge to be executed in the sustaining steps I of the subfields SF1-SF8 in accordance with the average brightness level of the input video signal of each field (steps S1 and S2). By executing steps S3-S13, the emission numbers T1-T8 are changed according to the peak brightness level of the input video signal of each field while maintaining the total emission number (T1+T2+T3+ . . . +T8). In other words, the number of light OFF subfields EN, to indicate the number of subfields of which all the pixel cells are in the light OFF mode, is determined based on this peak brightness level (step S3). Here the subfields indicated by the number of light OFF subfields EN are selected from all the subfields SF1-SF8 in the sequence of larger brightness weight, and the emission number decrease amount K0 is subtracted from the number of emission T allotted to the subfield concerned, such that the result is taken as a new number of emission T for that subfield (steps S11-S13). On the other hand, for the number of emission T allotted to each of the remaining subfields, the emission number increase amount K1 is added to the number of emission T and the result is taken as a new number of emission T (steps S8-S10).

In other words, in the process of setting the number of sustaining discharge shown in FIG. 5, the number of emission to be assigned to each subfield is first decided according to the average brightness level of the input video signal. Then, based on the peak brightness level of the input video signal, the subfields in which all pixel cells become light OFF mode are found, and the numbers of emission assigned to the subfields to be light OFF mode are decreased. At the same time, the numbers of emission assigned to other subfields are increased for the amount of the above decrease of the number of emission.

Therefore, for the input video signal indicating an image which is low brightness throughout the screen and has a small brightness difference, the number of emission (period) to be assigned to each of the subfields used to display the image can be increased without increasing the total emission number within one field.

Thus, when power consumption control is performed to assign the number of emission to each subfield according to the average brightness level of the input video signal, a good image with a higher visual brightness for an entire image is displayed, even if an image of which brightness is low and brightness difference is small is displayed.

In the above described embodiment, the subfields in which all the pixel cells become the light OFF mode are detected based on the peak brightness level of the input video signal, and the number of emission assigned to the subfields to become the light OFF mode is decreased. Alternatively, the subfields to be the light OFF mode may not be executed. This modification will be described below as a second embodiment.

### Embodiment 2

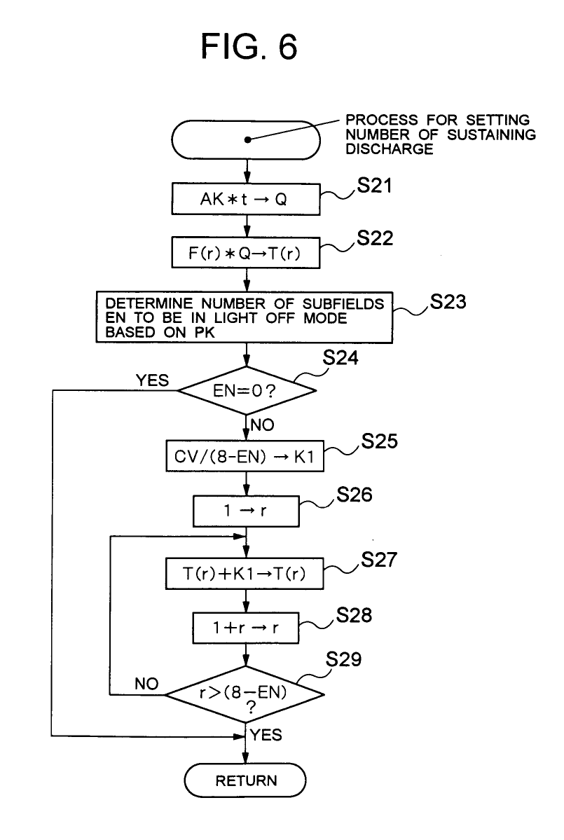

Referring to FIG. 6, a flowchart used in the second embodiment will be described. FIG. 6 depicts another way of determining the number of sustaining discharge. The same reference numerals and symbols are used in the first and second embodiments.

In FIG. 6 the drive control circuit 2 multiplies the average brightness level of each field indicated by the average brightness signal AK by a predetermined coefficient t so as to determine the emission number coefficient Q (step S21). The average brightness signal AK is supplied from the average brightness detection circuit 1. Then the drive control circuit 2 multiplies each of the brightness coefficients F1-F8 by the emission number coefficient Q, so as to determine the number of emission T1-T8 in the sustaining step I of each subfield SF1-SF8 (step S22). The brightness coefficients F1-F8 indicate the brightness weight of the subfields SF1-SF8.

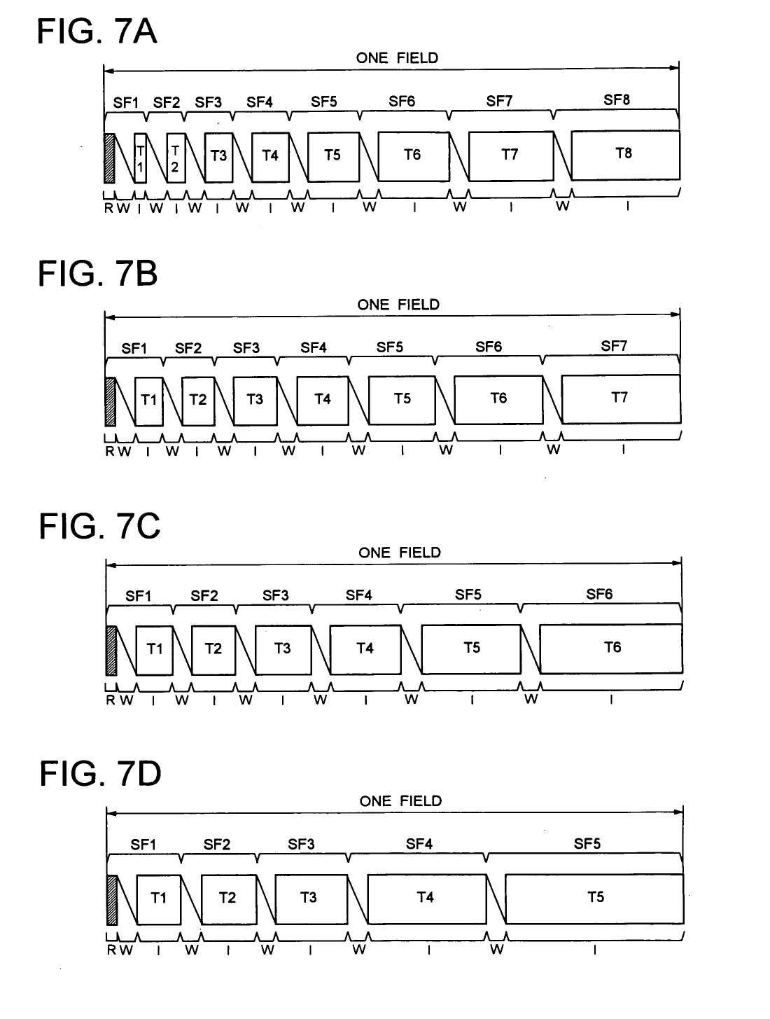

Then the drive control circuit 2 detects the subfields of which all the pixel cells become the light OFF mode status among the subfields SF1-SF8 based on the peak brightness signal PK supplied from the peak brightness detection circuit 3 and takes the number of these subfields as the number of light OFF subfields EN (step S23). Then the drive control circuit 2 determines whether the number of light OFF subfields EN is “0” (step S24). If it is determined that the number of light OFF subfields EN is “0” in step S24, the drive control circuit 2 ends the sustaining time setting processing, and moves to the execution of the drive control according to the emission drive sequence shown in FIG. 7A. In other words, the numbers of emission T1-T8 obtained in step S2 are set as the numbers of times (periods) of the sustaining discharge to be executed in the sustaining steps I of the subfields SF1-SF8. The emission drive sequence shown in FIG. 7A is the same as the emission drive sequence shown in FIG. 4.

If it is determined that the number of light OFF subfields EN is not “0” in step S24, on the other hand, the drive control circuit 2 divides the predetermined adjustment value (i.e., the emission number change amount) CV by a value acquired when the number of light OFF subfields EN is subtracted from the total number of subfields “8”, and takes the result as the emission number increase amount K1 (step S25). Then the drive control circuit 2 places “1” as the initial value of the subfield designation value r (step S26). The drive control circuit 2 selects the number of emission T(r) indicated by the subfield designation value r from the numbers of emission T1-T8 obtained in step S22, adds the emission number increase amount K1 to the number of emission T(r) and takes the sum as a new number of emission T(r) (step S27). Then the drive control circuit 2 adds “1” to the subfield designation value r and takes the result as a new subfield designation value r (step S28). The drive control circuit 2 determines whether the subfield designation value r is greater than the value acquired by subtracting the number of light OFF subfields EN from the total number of subfields “8” (step S29). If the answer in step S29 is NO, the drive control circuit 2 returns to step S27, and repeats the above mentioned operation. If the answer in step S29 is YES, on the other hand, the drive control circuit 2 ends the process of setting the number of sustaining discharge. In this instance, the drive control circuit 2 moves to the execution of modified drive control. Specifically, the emission drive sequence of FIG. 7A is modified by omitting one or more subfields among the subfields SF1-SF8. The subfields with a large brightness weight, for the number of the light OFF subfields EN, are subtracted from the subfields SF1-SF8.

When the number of light OFF subfields EN is “1”, for example, the drive control circuit 2 executes the drive control on the PDP 10 according to the emission drive sequence shown in FIG. 7B. Each field has seven subfields SF1-SF7 in FIG. 7B, i.e., one subfield is omitted from FIG. 7A. The new numbers of emission T1-T7 are prepared by performing the adjustment processing of steps S27-S29 on the numbers of emission T1-T7 obtained in step S22, and are set as the numbers of times (period) of the sustaining discharge to be executed in the sustaining steps of the subfields SF1-SF7. When the number of light OFF subfields EN is “2”, the drive control circuit 2 executes the drive control on the PDP 10 according to the emission drive sequence shown in FIG. 7C which includes only six subfields SF1-SF6 in each field. The new numbers of emission T1-T6 are prepared by performing the emission number change processing of steps S27-S29 on the numbers of emission T1-T6 obtained in step S22, and are set as the numbers of times (periods) of the sustaining discharge to be executed in the sustaining steps I of the subfields SF1-SF6. When the number of light OFF subfields EN is “3”, the drive control circuit 2 executes the drive control on the PDP 10 according to the emission drive sequence shown in FIG. 7D which includes only five subfields SF1-SF5 in each field. The new numbers of emission T1-T5 are prepared by performing emission number change processing of steps S27-S29 on the emission numbers T1-T5 obtained in step S22, and are set as the numbers of times (periods) of the sustaining discharge to be executed in the sustaining steps I of the subfields SF1-SF5.

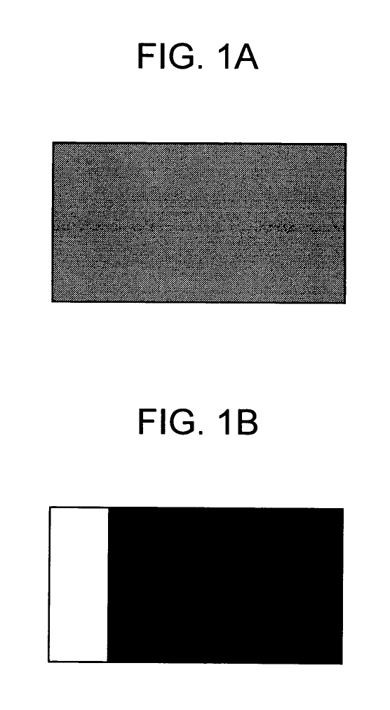

As described above, in the process of setting the number of sustaining discharge shown in FIG. 6, the number of emission to be assigned to each subfield is set according to the average brightness level of the input video signal. Then, based on the peak brightness level of the input video signal, the subfields of which all the pixel cells become the light OFF mode are detected, and grayscale driving is executed only in the subfields excluding these light-OFF-mode subfields. The number of emission to be assigned to each subfield is increased for the amount (numbers) of emission assigned to the light-OFF-mode subfields. Therefore good images with a higher visual brightness for an entire image can be displayed, even when the low power consumption control is performed for input video signal with low brightness and a small brightness difference as shown in FIG. 1A.

This application is based on a Japanese Patent Application No. 2004-130766 filed on Apr. 27, 2004, and the entire disclosure thereof is incorporated herein by reference.

1. A display panel drive method for driving a display panel, on which a plurality of pixel cells are provided, based on an input video signal for each of a plurality of subfields, with a number of emission of said pixel cells being assigned to each said subfield, said method comprising:
a peak brightness detection step for detecting a peak brightness level of said input video signal;
an emission number change step for changing said number of emission assigned to each said subfield based on said peak brightness level of said input video signal; and
a sustaining step for applying a sustain pulse to said display panel to cause said pixel cells to emit light for the number of emission assigned to the subfield concerned, during the subfield concerned.

2. The display panel drive method according to claim 1, wherein said emission number change step includes:
detecting a light OFF subfield, in which all of said pixel cells are in an unlit status, among said plurality of subfields based on said peak brightness level of said input video signal; and
decreasing said number of emission assigned to said light OFF subfield, while increasing said number of emission assigned to other subfields in said plurality of subfields.

3. The display panel drive method according to claim 2, wherein said decreasing said number of emission assigned to said light OFF subfield is making said number of emission zero.

4. A display panel drive method for driving a display panel, on which a plurality of pixel cells are provided, for each of a plurality of subfields constituting each field of an input video signal, said method comprising:
an average brightness detection step for detecting an average brightness level of the input video signal;
a peak brightness detection step for detecting a peak brightness level of said input video signal;
an emission number setting step for assigning a number of emission of said pixel cells to each said subfield based on said average brightness level and said peak brightness level; and
a sustaining step for applying a sustain pulse to said display panel to cause said pixel cells to emit light for said number of emission assigned to the subfield concerned, during the subfield concerned.

5. The display panel drive method according to claim 4, wherein said emission number setting step includes:
assigning said number of emission to each said subfield based on said average brightness level of said input video signal;
detecting a light OFF subfield, in which all of said pixel cells are in an unlit status, among said plurality of subfields based on said peak brightness level of said input video signal; and
decreasing said number of emission assigned to said light OFF subfield, while increasing said number of emission assigned to other subfields in said plurality of subfields.

6. The display panel drive method according to claim 4, wherein said emission number setting step includes:
assigning said number of emission to each said subfield based on said average brightness level of said input video signal;
detecting a light OFF subfield, in which all of said pixel cells are in an unlit status, among said plurality of subfields based on said peak brightness level of said input video signal; and
increasing said number of emission assigned to other subfields than said light OFF subfield among said plurality of subfields, for the number of said number of emission assigned to said light OFF subfield, and wherein said sustaining step applies said sustain pulse only in said other subfields than said light OFF subfield.

7. The display panel drive method according to claim 5, wherein said decreasing said number of emission assigned to said light OFF subfield is making said number of emission zero.

8. An apparatus for driving a display panel, on which a plurality of pixel cells are provided, based on an input video signal for each of a plurality of subfields constituting each field of said input video signal, said apparatus comprising:
first means for detecting an average brightness level of the input video signal;
second means for detecting a peak brightness level of said input video signal;
third means for assigning a number of emission of said pixel cells to each said subfield based on said average brightness level and said peak brightness level; and
fourth means for applying a sustain pulse to said display panel to cause said pixel cells to emit light for said number of emission assigned to the subfield concerned, during the subfield concerned.

9. The apparatus according to claim 8, wherein said third means includes:
means for assigning said number of emission to each said subfield based on said average brightness level of said input video signal;
means for detecting a light OFF subfield, in which all of said pixel cells are in an unlit status, among said plurality of subfields based on said peak brightness level of said input video signal; and
means for decreasing said number of emission assigned to said light OFF subfield, while increasing said number of emission assigned to other subfields in said plurality of subfields.

10. The apparatus according to claim 8, wherein said third means includes:
means for assigning said number of emission to each said subfield based on said average brightness level of said input video signal;
means for detecting a light OFF subfield, in which all of said pixel cells are in an unlit status, among said plurality of subfields based on said peak brightness level of said input video signal; and
means for increasing said number of emission assigned to other subfields than said light OFF subfield among said plurality of subfields, for the number of said number of emission assigned to said light OFF subfield, and wherein said fourth means applies said sustain pulse only in said other subfields than said light OFF subfield.

11. The apparatus according to claim 9, wherein said means for decreasing said number of emission assigned to said light OFF subfield makes said number of emission zero.
